(19) United States
(12) Patent Application Publication
(10) Pub. No.: US 2019/0039739 A1
(43) Pub. Date: Feb. 7, 2019

(54) AIRCRAFT AND WARNING DEVICE OF AN AIRCRAFT

(71) Applicants: Lufthansa Technik AG, Hamburg (DE); DEUTSCHE LUFTHANSA AKTIENGESELLSCHAFT, Cologne (DE)

(72) Inventors: Kirsten Winter, Bodenheim (DE); Tarquinio Witzemann, Hamburg (DE); Robert Nyenhuis, Mainz (DE); Werner Knorr, Niddatal (DE); Torsten Conrad, Kleinblittersdorf (DE); Jens Peter, Saarbruecken (DE); Michael Mueller, Saarbruecken (DE); Andrei Chirokolava, Saarbruecken (DE)

(73) Assignees: Lufthansa Technik AG, Hamburg (DE); DEUTSCHE LUFTHANSA AKTIENGESELLSCHAFT, Cologne (DE)

(21) Appl. No.: 16/076,327

(22) PCT Filed: Feb. 8, 2017
(86) PCT No.: PCT/EP2017/052732

§ 371 Date: Aug. 8, 2018

(30) Foreign Application Priority Data
Feb. 9, 2016 (DE) 10 2016 201 924.4

(51) Int. Cl. B64D 13/06; G01N 15/06; B64D 43/00

(52) U.S. Cl. CPC B64D 13/06; G01N 15/06; G01N 2015/0026; B64D 2013/0651; B64D 43/00

(57) ABSTRACT

An aircraft having at least two aero engines is provided with an air diverter configured to divert bleed air from the aero engines in order to supply air to an air-conditioning system of an aircraft cabin; an air-quality sensor configured to monitor air quality of the bleed air diverted from at least one of the aero engines and, on detection of pollution, to transmit a signal; and an indicator configured to display an indication depending on the signal transmitted from the air-quality sensor.

### CROSS-REFERENCE TO PRIOR APPLICATIONS

This application is a U.S. National Stage Application under 35 U.S.C. § 371 of International Application No. PCT/EP2017/052732 filed on Feb. 8, 2017, and claims benefit to German Patent Application No. DE 10 2016 201 924.4 filed on Feb. 9, 2016. The International Application was published in German on Aug. 17, 2017 as WO 2017/137429 A1 under PCT Article 21(2).

### FIELD

The present invention relates to an aircraft and a warning device of an aircraft.

### BACKGROUND

In some aircraft, the compressed air required for operating the air-conditioning system for the interior of aircraft, which is also referred to as bleed air, is diverted from a compressor stage of an aero engine. The line for carrying the bleed air is accordingly also referred to as a bleed duct.

As the aero engine has a plurality of bearings which are lubricated by means of a lubricant, such as oil for example, a leak can occur as a result of a technical fault and small quantities of pollutant can then get into the bleed air and thus lead to an unpleasant “engine oil smell” in the cabin air. As the bleed air is diverted from the compressor stages of various engines and is combined before feeding into the aircraft cabin, it is not possible to identify the engine at fault solely from the perception of the “engine oil smell” in the cabin.

To rectify this “engine oil smell” and to identify the engine at fault, in a first step, the cockpit crew successively switch off and, after a short time, reconnect the individual bleed air connections of the engines and check whether the “engine oil smell” still occurs in the cabin air. When the engine at fault has been identified, the bleed air feed from this engine is subsequently switched off and the “engine oil smell” is rectified. In this case, the subjective estimation by the crews' noses determines whether an “engine oil smell” occurs and by which of the engines the “engine oil smell” is caused. On average, this searching for the source takes approx. 20 minutes and is based solely on the subjective feeling of the crew. Further, this switching on and off of the bleed air feeds includes an at least brief further feeding-in of the contaminated bleed air until the engine at fault has been identified.

After a so-called “engine oil smell” in flight, a check can be carried out on the ground with hand detectors, wherein the aero engines must also be switched on and off individually until the engine at fault has been identified. Such a run-up is laborious and fundamentally time, cost and personnel intensive. At the same time, it is possible that the “engine oil smell” does not occur on the ground, as the operating and ambient conditions of the engines on the ground and in the air are quite different, so that an identification of the engine causing the “engine oil smell” is no longer possible on the ground.

Different measuring methods and measuring devices, which can be connected to the engine from the outside and by means of which a contamination of the bleed air can be detected when the aircraft is on the ground, are known from publications US 2005/0229686 A1, U.S. Pat. No. 8,938,973 B2 and EP 1 701 160 A1. An identification of the engine at fault in flight is not possible by this means.

### SUMMARY

In an embodiment, an aircraft having at least two aero engines is provided with an air diverter configured to divert bleed air from the aero engines in order to supply air to an air-conditioning system of an aircraft cabin; an air-quality sensor configured to monitor air quality of the bleed air diverted from at least one of the aero engines and, on detection of pollution, to transmit a signal; and an indicator configured to display an indication depending on the signal transmitted from the air-quality sensor.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows an aircraft having a line system for feeding bleed air from the aero engines into the aircraft cabin;

FIG. 2 shows an enlarged aero engine having a line system for removing bleed air;

FIG. 3 shows an air-quality sensor device having an optical sensor in an embodiment;

FIG. 4 shows an air-quality sensor device having an optical sensor in an embodiment;

FIG. 5 shows a line system having a branch line and an inspection window;

FIG. 6 shows an aircraft having a warning device according to an embodiment of the invention in a schematic diagram;

FIG. 7 shows an indicator device of a warning device according to an embodiment of the invention, and

FIG. 8 shows an air-quality sensor device, wherein the sensor is formed by a metal oxide sensor.

### DETAILED DESCRIPTION

Embodiments of the present invention provide an aircraft and a warning device that improves the reliability of an “engine oil smell” detection.

For example, an embodiment of the present invention relates to an aircraft having at least two aero engines having a device for diverting bleed air from the various aero engines in order to supply air to an air-conditioning system of an aircraft cabin, and a warning device for an “engine oil smell” in an aircraft cabin of an aircraft having at least two aero engines, and a device for diverting bleed air from the various aero engines in order to supply air to an air-conditioning system of an aircraft cabin.

According to an embodiment of the invention, at least one air-quality sensor device is provided, which is designed to monitor the air quality of the bleed air diverted from at least one of the aero engines and, on detection of pollution, to transmit a signal, and at least one indicator device is provided, which displays a signal depending on the signal transmitted from the air-quality sensor device.

Here, the term bleed air includes the air stream diverted from the aero engine both upstream and downstream of the aircraft's on-board air-conditioning system in which the bleed air is conditioned for introduction into the aircraft cabin. Certain improvements provided by embodiments of the invention are therefore based on two steps; the air-quality of the bleed air is first detected objectively by the air-quality sensor device so that pollution in the bleed air can be detected independently of the subjective sensing ability of the crew. Secondly, a signal, which objectively displays pollution of the bleed air detected by the air-quality sensor device and actively draws the crew's attention to pollution of the bleed air, is displayed by the indicator device provided. If the specified limiting value of the pollution of the bleed air, which is to be exceeded for transmitting the warning signal, is chosen to be appropriately small, the crew's attention can then also be drawn to pollution when the pollution is not yet objectively perceivable by the crew.

Further, in an embodiment at least two air-quality sensor devices, which separately detect the air quality of the bleed air diverted from the various aero engines, are provided in the aircraft, and an indicator device is provided which displays an aero-engine-individualised signal depending on the signals from the various air-quality sensor devices.

According to aspects of the present invention, the air quality of the bleed air diverted from the engines can be separately detected by the air-quality sensor devices. Further, as the indicator device signal is an aero-engine-individualised signal, an immediate conclusion regarding the engine at fault can also be drawn, thus enabling the relevant bleed-air connection to be blocked and the “engine oil smell” to be quickly rectified. The aircraft-engine-individualised signal can then be logged so that appropriate maintenance measures can subsequently be taken on the ground without a further run-up being required to identify the engine at fault.

Embodiments of the invention therefore enable detection of pollution of the bleed air in real time along with a simultaneous identification of the engine, thus enabling measures for the most reliable rectification possible of the “engine oil smell” to be taken quickly. In addition, the “engine oil smell” does not have to have occurred in the aircraft cabin and therefore have been perceivable, provided that just one of the air-quality sensor devices generates an appropriate signal. As a result of the separate detection of the bleed air diverted from the aero engines, the air-quality sensor devices are in practice associated with the sources of the bleed air and thus enable a very early warning if the bleed air of one of the aero engines is polluted.

Further, in an embodiment, a common evaluation unit is provided, to which the signals of the air-quality sensor devices are fed and which generates the signal for display in the indicator device from the signals of the air-quality sensor devices. As a result of the proposed solution, a very simple system architecture including the air-quality sensor devices, the indicator device and the interposed common evaluation unit can be realised. Pre-determined limiting values can then be stored in the evaluation unit with an appropriate evaluation algorithm in which the signals of the air-quality sensor devices are processed, wherein the aero-engine-individualised signal is then displayed on the indicator device when one of the signals of the air-quality sensor devices exceeds the limiting values. Alternatively, the signals of the air-quality sensor devices can also be only processed and displayed directly on the indicator device, wherein exceeding the specified limiting values can then be signalled by a change in the display of the measured values, such as by a colour change for example. At the same time, the evaluation unit can be designed as an individual component or also be integrated into the on-board electronics. If the proposed solution is designed as a retrofit solution for aircraft that are already flying, the evaluation unit lends itself to being designed as a separate component so that intervention in the on-board electronics is unnecessary.

Further, the indicator device can also have a plurality of display fields or display elements each associated with an aero engine or a group of aero engines, and the aero-engine-individualised signal can be realised by displaying a signal on one of the display fields or by activating one of the display elements. As a result of the plurality of display fields or display elements, the signal can be individualised with reference to an engine by displaying a signal on a display field associated with the relevant aero engine or by actuating a display element associated with the engine. The engine at fault can therefore be identified very easily based on which of the display elements is in fact actuated or on which display field a corresponding signal is generated.

In an exemplary embodiment, the indicator device can be designed particularly cost effectively and, at the same time, in an easily distinguishable minor, in that the display elements are formed by LEDs.

Further, in a preferred embodiment, the air-quality sensor devices can be formed by optical sensor devices which have at least one light source radiating into the bleed air and at least one photodiode detecting the reflection of the radiated light. In the case where oil or other polluting particles are present in the bleed air, the light radiated by the light source is reflected thereby onto the photodiode, which thereupon generates a signal. Further, at the same time, use is made of the advantage that the oil has fluorescing properties, so that the light radiated from the light source and reflected is additionally amplified by the fluorescing properties.

In doing so, the fluorescing effect and the amplification of the reflected light by the oil particles are intensified particularly strongly when the light source is a UV light source.

Further, in an embodiment, the indicator device is arranged in a cockpit of the aircraft. As a result, the attention of the crew members and, in particular, the aircraft captain in the cockpit, can be drawn as quickly as possible to the presence of an “engine oil smell”, thus enabling them to introduce appropriate countermeasures as directly and as early as possible.

Further, the air-quality sensor devices can each have a filter arranged in a flow line of the bleed air. As a result of the filter, the particles are collected so that a greater quantity of particles adheres thereto even at very low particle concentrations in the bleed air. In this case, the sensors of the air-quality sensor devices are directed towards the filter or coupled to the filter and detect the particles adhering to the filter. This increased quantity of particles on the filter enables even very low particle volume concentrations in the bleed air to be detected. The filters can be formed, for example, by Millipore membrane filters.

Further, filters can also be arranged upstream of the sensor devices in order to protect the air-quality sensor devices against damage and therefore to maintain their functionality.

In particular, the air-quality sensor devices can have a sensor arranged in a flow line of the bleed air. As a result of the proposed development, the bleed air flows directly around the sensors. If the sensor is arranged in the so-called bleed duct, the bleed air introduced into the aircraft cabin flows directly around the sensor so that the detected signal represents the air quality of the bleed air introduced into the cabin directly and without adulteration. Further, the flow line can also be a branch line of the bleed duct in which part of the bleed air is fed out of the bleed duct and over the sensor. In this case too, pollution of the bleed air leads directly to a signal of the air-quality sensor device and to a signal of the indicator device. However, the provision of a branch line can offer advantages with regard to the design of the connection of the air-quality sensor device.

Further, in this case, at least one pressure-reducer, which reduces the static pressure in the flow line of the bleed air and which is arranged upstream of the sensor in the flow direction, can be provided. The bleed air diverted from the compressor has a higher static pressure which is deliberately reduced by the pressure-reducer, as a result of which the forces acting on the sensor can be reduced.

Further, at least one nozzle, preferably a Venturi nozzle, which is arranged upstream of the sensor in the flow direction, can be arranged in the flow line of the bleed air.

The nozzle and the pressure-reducer enable constant pressure and flow conditions to be produced in the bleed air flowing past the sensor, as a result of which the measuring accuracy of the sensor can be increased. Further, it is proposed that a branch line connected to a flow line of the bleed air is provided, and the air-quality sensor devices detect the air quality of the bleed air in the relevant branch line. The bleed air diverted into the branch line is representative of the bleed air diverted from the relevant engine. Here, the branch line for connecting the air-quality sensor device can be formed and designed individually, or it can also be part of the air-quality sensor device itself

Further, it is proposed that the air-quality sensor device and the indicator device are designed to monitor the air quality and to display the signal when the aircraft is on the ground and when the aircraft is in the air. As a result of the proposed solution, the signals of the air-quality sensor devices can be displayed via the indicator device in real time during a flight, so that a warning of an “engine oil smell” can be indicated directly independently of the subjective feeling of the crew and also independently of pollution of the cabin air perceptible in the aircraft cabin, namely independently of whether the aircraft is on the ground or in the air.

Further, it is preferred that the air-quality sensor device and the indicator device be designed to continuously monitor the air quality and continuously display the signal. As a result of the continuous monitoring and display of the signal, firstly the time of occurrence can be accurately determined retrospectively, as a result of which finding the source of the fault in conjunction with possible operating parameters of the aero engine can be carried out more easily. Secondly, a fault in the air-quality sensor device or indicator device can be detected more easily by the continuous detection of the air quality and display of the signal, for example if the indicator device no longer displays a signal.

Further, in an embodiment, a warning device for an “engine oil smell” in an aircraft cabin of an aircraft having at least two aero engines, and a device for diverting bleed air from the various aero engines in order to supply air to an air-conditioning system of an aircraft cabin is provided, wherein at least two air-quality sensor devices are provided which separately detect the quality of the bleed air diverted from the various aero engines, and an indicator device is provided which displays an aero-engine-individualised signal depending on the signals from the various air-quality sensors.

Here, the aircraft cabin includes both the aircraft cockpit and the passenger cabin and, where applicable, crew accommodation and cargo hold.

The warning device can be fitted in a finished aircraft as a retrofit solution, wherein the advantages to be achieved justify the comparatively low costs of the air-quality sensor devices and the indicator device in all cases. Further, the warning device can also be integrated into an aircraft system right at the planning stage before starting the aircraft design, wherein the warning device can also interact with other aircraft systems.

The invention is explained below based on preferred embodiments with reference to the accompanying figures.

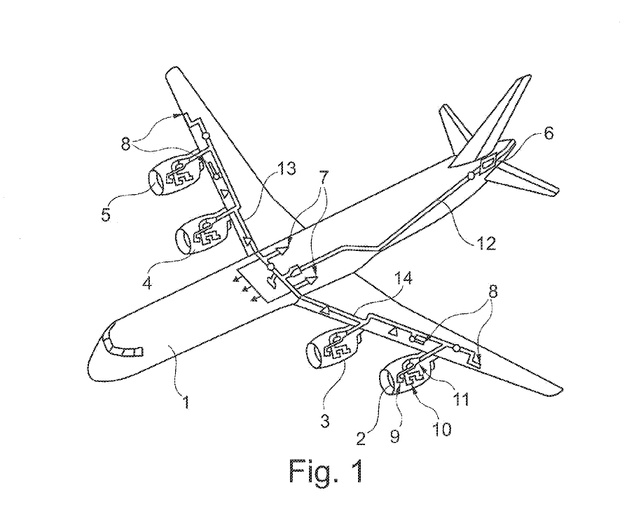

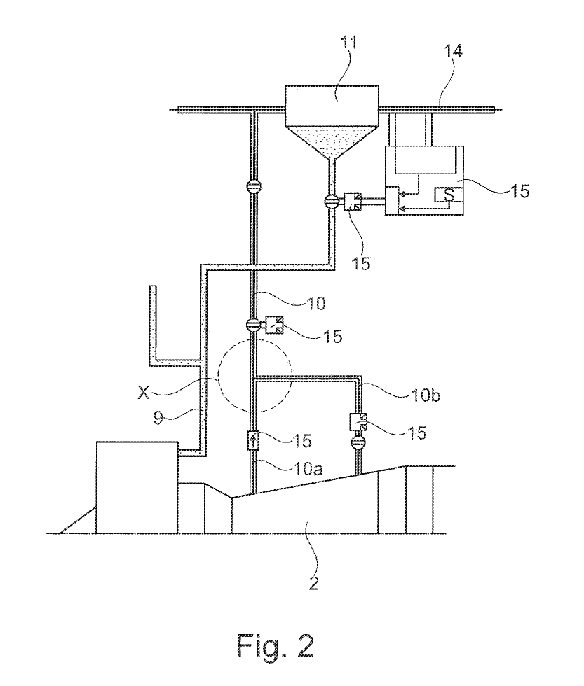

An aircraft 1 having five aero engines 2, 3, 4, 5 and 6 designed as jet engines can be seen in FIG. 1, wherein the aero engine 6 arranged in the region of the rear elevator is only a so-called Auxiliary Power Unit (APU) which serves substantially to supply air and energy to various units, including the air-conditioning system, on the ground. An aero engine 2 together with removal of the bleed air can be seen in an enlarged diagram in FIG. 2.

Bleed air is in each case removed from the compressor stages of the aero engines 2, 3, 4, 5 and 6 via flow lines 9 and 10 and combined via flow lines 12, 13 and 14 and fed to an air-conditioning system for the aircraft cabin via branches 7. The flow lines 9 and 10 are only provided with references in the aero engine 2 but are, of course, also provided in the aero engines 3, 4, 5 and 6.

The bleed air is removed from the fan of the aero engine 2 via a flow line 9 and from a compressor stage of the aero engine 2 via a pair of flow lines 10a and 10b. In doing so, the bleed air is diverted from the fifth stage of the low-pressure section via the flow line 10a and from the ninth stage of the high-pressure section of the compressor via the flow line 10b. The partial flows of the bleed air are then recombined in the flow line 10 and finally fed to a pre-cooler 11, to which the bleed air from the flow line 9 of the fan is also fed. After emerging from the pre-cooler 11, the bleed air is then fed into the air-conditioning system of the aircraft cabin via the flow line 14. The bleed air feed via the flow lines 9, 10a, 10b and 10 can be connected, disconnected and also controlled in volume by a plurality of valves and associated control devices 15. To this extent, the aircraft 1 corresponds to the prior art.

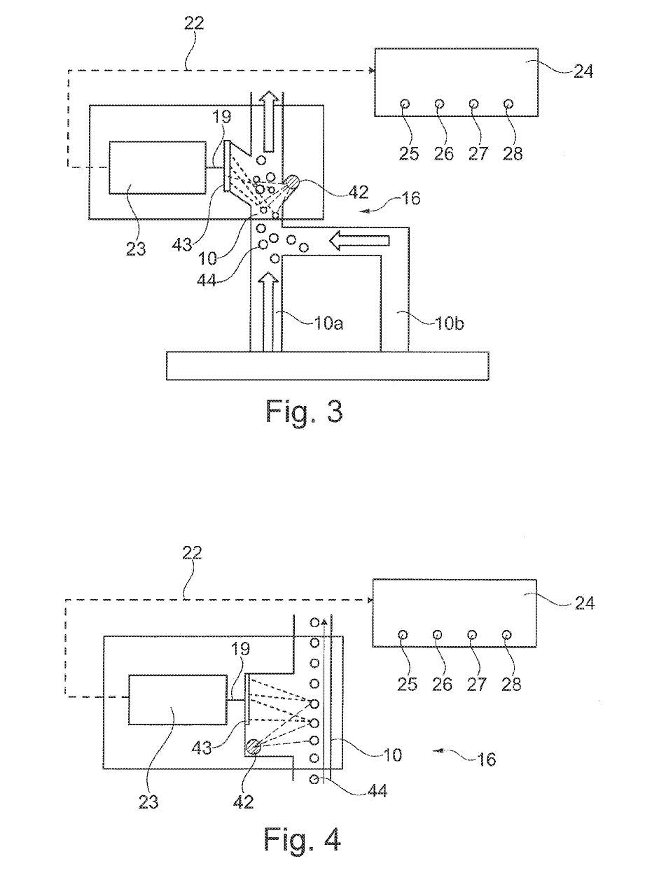

The detail X of FIG. 2 can be seen in an enlarged form in various embodiments in FIGS. 3, 4 and 5. The bleed air diverted from the compressor stage via the flow lines 10a and 10b is combined in the flow line 10 in which, in the exemplary embodiments of FIGS. 3 and 4, an air-quality sensor device 16 is provided in each case. Depending on the position of the air-quality sensor device 16 in the flow lines 9, 10, 12, 13 or 14, said device can detect the bleed air diverted from the fan or the compressor stage separately or also the bleed air diverted from a single aero engine 2, 3, 4, 5, 6 or also the bleed air diverted from a group of, for example, two aero engines 2, 3, 4, 5 or 6 after being combined.

In the exemplary embodiment of FIG. 3, the air-quality sensor device 16 is formed by an optical sensor device and includes a light source 42 and a photodiode as sensor 43, which is connected to an evaluation unit 23. The light source 42 radiates into the flow line 10 into the bleed air. If engine oil 44 is present in the bleed air, the light radiated from the light source 42 is reflected by the engine oil 44 onto the photodiode, which thereupon generates a signal. The light source 42 and the sensor 43 are arranged on different sides of the flow line 10. An air-quality sensor device 16, which works on the same measuring principle and in which the light source 42 and the sensor 43 are arranged on the same side of the flow line 10, can be seen in the exemplary embodiment of FIG. 4. In both air-quality sensor devices 16, the sensor 43 is in each case positioned such that light 42 radiated from the light source 42 can only impinge upon the sensor 43 by reflecting off the engine oil 44 so that, in the event that no engine oil 44 is present in the bleed air, the sensor 43 does not output a signal.

The signal from the sensor 43 is connected via a signal line 19 to the evaluation unit 23, which for its part is in turn connected via a signal line 22 to an indicator device 24. Four indicator elements 25, 26, 27, 28 in the form of light emitting diodes (LEDs) are provided on the indicator device 24. Each of the light emitting diodes is associated with one aero engine 2, 3, 4, 5, which is identified by the markings Eng1, Eng2, Eng3 and Eng4.

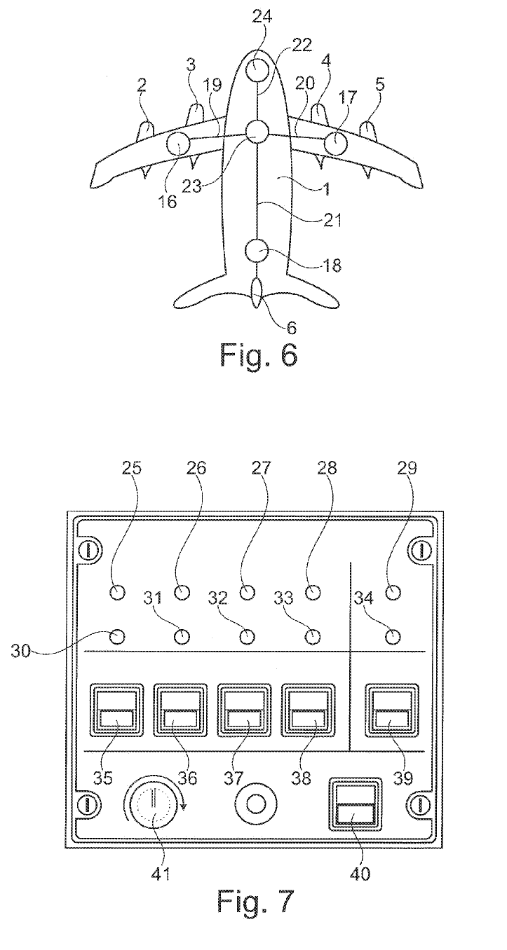

As can be seen in FIG. 6, further air-quality sensor devices 17 and 18 are provided in the aircraft 1. Here, the air-quality sensor devices 16 and 17 are associated with the flow lines designated by references 13 and 14 in FIG. 1 in which, after combining, the bleed air from the two adjacent aero engines 2 and 3 or 4 and 5 is fed to the connections 7 of the air-conditioning system. However, additional air-quality sensor devices can be provided so that the bleed air diverted from the aero engines 2, 3, 4 and 5 is detected separately. If an air-quality sensor device is associated with each of the aero engines 2, 3, 4 and 5, in the event of an occurrence of an “engine oil smell”, the aero engine 2, 3, 4 or 5 at fault can be identified directly. If the air-quality sensor devices 16 and 17 were each associated with one flow line 13 and 14 in which the bleed air from two aero engines 2 and 3 or 4 and 5 is fed to the air-conditioning system, it would only be possible to identify the pair of aero engines 2, 3 or 4, 5 causing the “engine oil smell”. Further, a third air-quality sensor device 18 is provided, which is likewise connected via a signal line 21 to the evaluation unit 23. Here, the third air-quality sensor device is associated with an additional aero engine 6 which is only used as an Auxiliary Power Unit (APU) when the aircraft 1 is on the ground and additional consumers, including the air-conditioning system for example, have to be supplied with energy or bleed air.

The signals from the air-quality sensor devices 16, 17 and 18 are processed in the evaluation unit 23 where they are compared with stored limiting values. If the pre-defined limiting values are exceeded, an appropriate warning signal is transmitted via the signal line 22 to the indicator device 24, which is shown in FIG. 7. As well as the indicator elements 25 to 28, the indicator device 24, which can be seen in FIG. 7, also includes additional indicator elements 29 to 34 which are formed by light emitting diodes and, based on the markings of the individual aero engines 2, 3, 4, 5 and 6 and pollution of the bleed air, are associated either with engine oil (OIL) or other possible pollutants, for example de-icing fluid or hydraulic fluid (OTHER). If engine oil 44 or other pollutants are now detected in the bleed air by one or more of the air-quality sensor devices 16, 17 or 18, then an appropriate signal is generated by means of the evaluation unit 23 and one or more of the light emitting diodes on the indicator device 24 are illuminated accordingly. By choosing which of the light emitting diodes on the indicator device 24 illuminates, an aero-engine-individualised signal is generated which indicates to the crew directly and objectively that an “engine oil smell” or other contamination of the bleed air is present. Secondly, by choosing which light emitting diode is illuminated, it is indicated which of the aero engines 2, 3, 4, 5 or 6 is causing the “engine oil smell” or the contamination due to other substances, so that the bleed air removed from the relevant aero engine 2, 3, 4, 5 or 6 can be switched off by actuating the appropriate valve 15, and the “engine oil smell” or contamination of the cabin air can be actively and directly rectified in flight. If the limiting values are set appropriately low, the switching-off of the relevant bleed air could even be undertaken before the “engine oil smell” is actually perceivable in the aircraft cabin. In order to switch off the relevant bleed air, additional switches or sensor surfaces 35 to 39 associated with the aero engines 2, 3, 4, 5 and 6 are provided on the indicator device 24. As well as purely displaying the warning signal, the indicator device 24 therefore also serves as an actuating device and therefore forms a multifunctional unit for monitoring and controlling the bleed air in the aircraft 1. Further, an on-off switch 40 and a control dial 41 for controlling the brightness of the light emitting diodes are provided on the indicator device 24.

In the exemplary embodiments described, the air-quality sensor devices 16, 17 and 18 are designed as optical sensor devices, which is of advantage as the oil particles 44 present in the bleed air in the event of an “engine oil smell” have fluorescing properties and, as a result, amplify the light reflected onto the sensors 43 and the signal from the sensors 43. This fluorescing effect can be reinforced, in particular when a UV light source (black light source) is used as the light source 42.

Further, the sensors 43 can preferably be designed as semiconductor gas sensors (metal oxide semiconductor MOS) as static or dynamic (temperature-modulated). Alternatively, a sensor 43 of the following type can also used:
Infrared sensor (IR sensor)
Photo Ionisation Detector (PID sensor)
Electrochemical cell (NC sensor)
Carbon dioxide sensor (CO2)
Carbon monoxide sensor (CO)
Non-dispersive Infrared Sensor (NDIR)
Photoacoustic Spectroscopy (PAS)
Thermal Conductivity Sensor (TCD)
Pellistor (PEL)
Field Effect Transistor (FET)
Flame Ionisation Detector (FID)
Tunable Laser Diode Spectroscopy (TLDS)
TLDS with Cavity-Ring-Down (CRDS)
TLDS with photoacoustic detector (PAS)
Fourier Transformation IR Spectrometer (FTIR)
Particle sensor
Condensation Particle Counter (CPC)
Faraday Cup Electrometer (FCE)
Hygroscopic Tandem Differential Mobility Analyser (HTDMA)
Optical Particle Counter (OPC)
Scanning Mobility Particle Sizer (SMPS)
Single Particle Soot Photometer (SMSP)
Sensor array
Quartz crystal microbalance
Use of surface waves.

Further, embodiments of the present invention may also use the following measuring instruments and measuring methods as an air-quality sensor device for detecting the bleed air or the cabin or cockpit air :
Mass spectrometer (MS)
Ion mass spectrometer (IMS)
Laser ion mass spectrometer (LIMS)
Gas chromatograph (GC)

The advantage of these measuring instruments can be seen, in particular, in that the exact composition of the air can be detected therewith.

Further, the indicator device 24 with the indicator elements 25 to 34 for reproducing the aero-engine-individualised signal is described. The indicator device 24 can, however, also be designed as a display having a plurality of display fields or display surfaces. In doing so, the aero-engine-individualised signal can be formed in the reproduction of a special symbol, e.g. in the form of a symbolised aircraft, wherein the information relating to the occurrence of an “engine oil smell” is then generated by warning lamps appropriately positioned on the aircraft 1. Further, the aero-engine-individualised signal can also be formed simply by a sequence of words with an appropriate content reproduced on the display, such as e.g.: “Engine Oil Detected—ENG1”.

The indicator device 24 is advantageously positioned in such a way that it can be read at all times. In doing so, a place which the crew sees as frequently as possible is to be preferred, such as in the field of view of the cockpit crew or of the captain and of the co-pilot, for example.

Further, the detected data and, in particular, also the identification of the aero engine 2, 3, 4, 5 or 6 at fault can also be stored in a memory unit of the indicator device 24 or the evaluation unit 23 over an extended period so that the appropriate maintenance measures can subsequently be undertaken on the ground without a further run-up.

The air-quality sensor devices 16, 17 and 18 can preferably be mounted in a housing. At the same time, branch lines 45, which can be or are connected to the flow lines 9, 10, 12, 13 or 14, can be provided in the air-quality sensor devices 16, 17 and 18 so that the assembly of the retrofittable warning devices only requires appropriate connections on the flow lines 9, 10, 12, 13, 14 and accordingly adequate installation space. Further, in this embodiment, the evaluation unit 23 and the indicator device 24, which, however can also be combined as a structural unit, is provided. Finally, signals from the air-quality sensor devices 16, 17 and 18, evaluation unit 23 and the indicator device 24 only have to be connected to one another by means of appropriate signal lines 19, 20, 21, 22. The effort for retrofitting existing aircraft is therefore comparatively small.

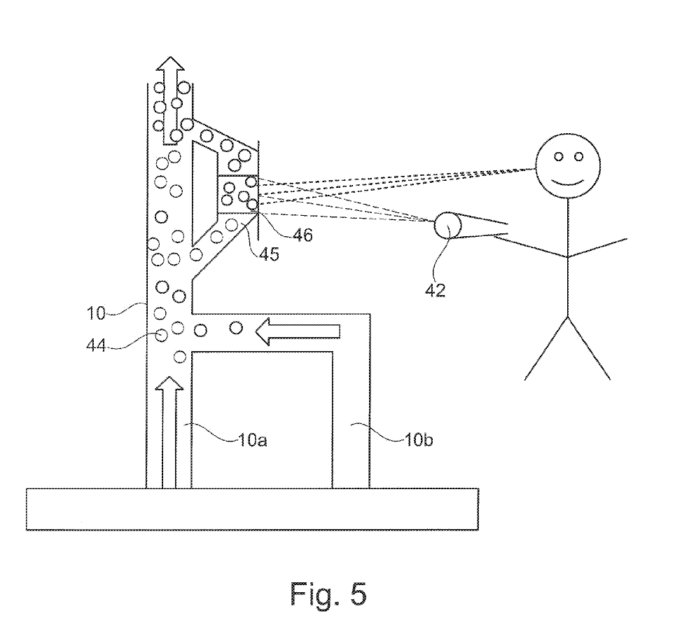

An embodiment having a simplified control option for detecting an “engine oil smell” in which a branch line 45 is connected to the flow line 10 can be seen in FIG. 5. A transparent inspection window 46 is provided in the branch line. In this case, the aero engine 2, 3, 4, 5 or 6 at fault can be detected very easily in that the maintenance personnel on the ground shine a light source 42 through the inspection window 46. In the event that oil particles 44 are present in the bleed air, the light is reflected and amplified by the fluorescing properties of the oil particles 44. The oil particles 44 then begin to illuminate, which can be visually perceived by the maintenance personnel.

This elegant solution requires solely an accessible branch line 45.

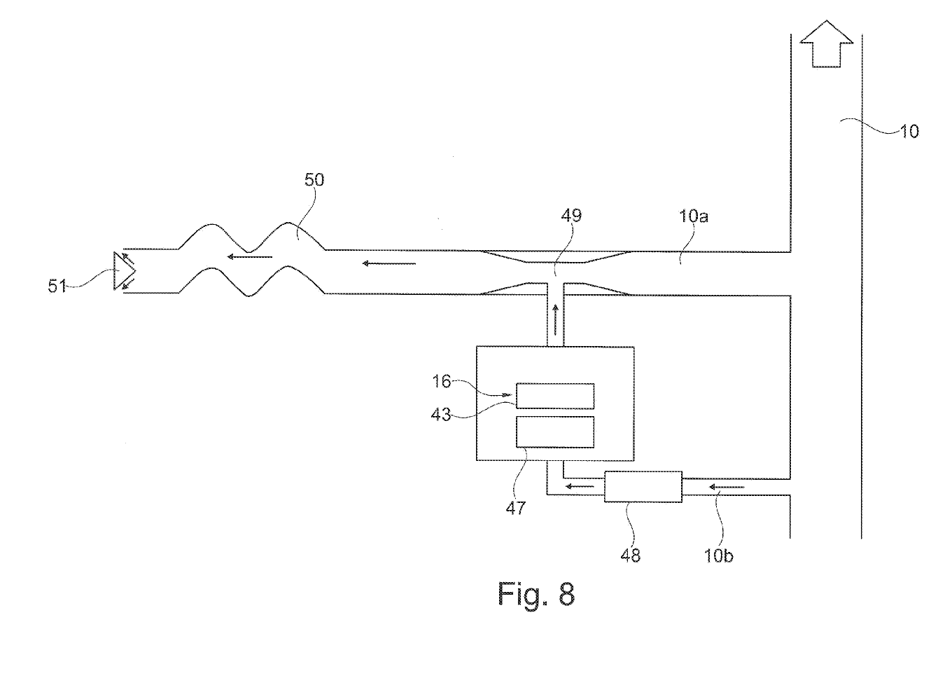

A solution in which the sensor 43 is formed by a metal oxide sensor can be seen in FIG. 8, wherein a temperature-modelled semiconductor sensor is preferably used. The advantages of such a sensor 43 can be seen in that, with a single sensor 43, an ageing-free and drift-free detection of the gases and vapours in the bleed air is possible. The sensitive semiconductor layer of metal oxide of the highly sensitive sensor is in contact with the diverted bleed air. The measured quantity here is the electrical resistance, which either decreases or increases based on the reactions occurring on the sensor surface, wherein the sensor can be operated with constant or preferably also with modulated temperature.

In doing so, use can be made of a plurality of sensors 43 of one or the same type or also of different types, which are provided by means of their design for detecting the bleed air in different measuring ranges, such as temperature and pressure ranges, for example. Alternatively, however, various sensors 43 of different type can be used if, for example, various constituents in the bleed air are to be detected. The measuring range, the sensitivity and ultimately also the accuracy of the air quality sensor device 16 can be improved by combining sensors 43 of different types or of the same type.

A filter 48, which filters the diverted bleed air and therefore additionally protects the air-quality sensor device 16 arranged downstream, is initially provided in the flow direction of the bleed air in the flow line 10b which is diverted from the flow line 10. As well as the actual sensor 43, the air-quality sensor device 16 additionally includes a critical nozzle 47 arranged upstream with reference to the flow direction of the diverted bleed air, in which nozzle the flow conditions in the diverted bleed air are adjusted to conditions which are matched to the sensor 43 or also to optimal conditions.

Further, a second flow line 10a connected to the flow line 10 is provided, in which a small amount of bleed air is likewise diverted from the flow line 10. A Venturi nozzle 49, to which the flow line 10b is connected in the region of the smaller cross section, is provided in the flow line 10b. In the Venturi nozzle 49, the diverted bleed air is accelerated and the static pressure in the bleed air is reduced, as a result of which the bleed air is sucked out of the flow line 10b. Together with the Venturi nozzle 49, the flow line 10a practically forms a suction device for producing a driving pressure difference in the flow line 10b between the inlet and the outlet. After flowing through the Venturi nozzle, the small quantity of diverted bleed air is then further guided in the flow line 10 through a cooling section 50 and finally, after cooling, released into the environment through a dispersal nozzle 51. Here, the Venturi nozzle 49 acts as a pressure reducer which reduces the static pressure in the diverted bleed air at a point arranged upstream of the air-quality sensor device 16 so that the bleed air is practically drawn through the air-quality sensor device 16.

As described, embodiments of the invention relate to an aircraft (1) having at least two aero engines (2, 3, 4, 5, 6), having a device for diverting bleed air from the various aero engines (2, 3, 4, 5, 6) in order to supply air to an air-conditioning system of an aircraft cabin. At least two air-quality sensor devices (16, 17, 18) are provided which separately detect the quality of the bleed air diverted from the various aero engines (2, 3, 4, 5, 6). An indicator device (24) may also be provided which displays an aero-engine-individualized signal depending on the signals from the various quality sensor devices (16, 17, 18).

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An aircraft having at least two aero engines the aircraft comprising:
an air diverter configured to divert bleed air from the aero engines in order to supply air to an air-conditioning system of an aircraft cabin;
an air-quality sensor configured to monitor air quality of the bleed air diverted from at least one of the aero engines and, on detection of pollution, to transmit a signal; and
an indicator configured to display an indication depending on the signal transmitted from the air-quality sensor.

2. The aircraft according to claim 1 comprising:
a plurality of air quality sensors, comprising the air quality sensor, which are configured to separately detect the air quality of the bleed air diverted from the aero engines, the air quality sensors configured to transmit signals, comprising the signal, based upon detecting the pollution,
wherein the indicator is configured to display an aero-engine-individualised indication depending on the signals from the air quality sensors.

3. The aircraft according to claim 2 comprising a common evaluator to which the signals of the air-quality sensors are fed and which is configured to generate the indication displayed by the indicator from the signals of the air-quality sensors.

4. The aircraft according to claim 2, or 3, wherein
the indicator has a plurality of display fields or display elements each associated with an aero engine or a group of aero engines of the aero engines, and
the aero-engine-individualised indication is realised by displaying an indication on one of the display fields or by activating one of the display elements.

5. The aircraft according to claim 4, wherein the display elements are formed by LEDs.

6. The aircraft according to claim 1, wherein the air-quality sensors comprise optical sensors which have at least one light source radiating into the bleed air and at least one photodiode detecting the reflection of the radiated light.

7. The aircraft according to claim 6, wherein the light source is a UV light source.

8. The aircraft according to claim 1, wherein the indicator is arranged in a cockpit of the aircraft.

9. The aircraft according to claim 1, wherein the air-quality sensor has a sensor arranged in a flow line of the bleed air.

10. The aircraft according to claim 9, wherein the sensor is formed by at least one metal oxide sensor.

11. The aircraft according to claim 9 comprising at least one pressure-reducer, which is configured to reduce the static pressure in the flow line of the bleed air and which is arranged upstream of the sensor in the flow direction.

12. The aircraft according to claim 9 comprising at least one nozzle arranged in the flow line of the bleed air.

13. The aircraft according to claim 1 comprising at least one branch line connected to a flow line of the bleed air,
wherein the air-quality sensor detects the air quality of the bleed air in its corresponding branch line.

14. The aircraft according to claim 1, wherein the air-quality sensor and the indicator are configured to monitor the air quality and to display the indication when the aircraft is on the ground and when the aircraft is in the air.

15. The aircraft according to claim 1, wherein the air-quality sensor and the indicator device are configured to continuously monitor the air quality and continuously display the indication.

16. A warning device for warning of an engine oil smell in an aircraft cabin of an aircraft, the aircraft having at least two aero engines and having an air diverter configured to divert bleed air from the aero engines in order to supply air to an air-conditioning system of the aircraft cabin, the warning device comprising:
an air-quality sensor, which is configured to monitor air quality of the bleed air diverted from at least one of the aero engines and, on detection of pollution, to transmit a signal; and
an indicator, which is configured to display an indication based on the signal transmitted from the air-quality sensor.

17. The warning device according to claim 16 comprising:
a plurality of air quality sensors, comprising the air quality sensor, which are configured to separately detect the air quality of the bleed air diverted from the aero engines, the air quality sensors configured to transmit signals, comprising the signal, based upon detecting the pollution,
wherein the indicator is configured to display an aero-engine-individualised indication depending on the signals from the air quality sensors.

18. The aircraft according to claim 12, wherein the at least one nozzle is a Venturi nozzle arranged upstream of the sensor in the flow direction.
